(19) United States
(12) Patent Application Publication
(10) Pub. No.: US 2015/0154059 A1
(43) Pub. Date: Jun. 4, 2015

(54) METHOD AND APPARATUS FOR IMPLEMENTING EXTENDED APPLICATION

(71) Applicant: TENCENT TECHNOLOGY (SHENZHEN) COMPANY LIMITED, Shenzhen (CN)

(72) Inventors: Yuelong TENG, Shenzhen (CN); Mengqing WU, Shenzhen (CN); Jinzhou JIANG, Shenzhen (CN)

(21) Appl. No.: 14/622,472

(22) Filed: Feb. 13, 2015

Related U.S. Application Data
(63) Continuation of application No. PCT/CN2013/081449, filed on Aug. 14, 2013.

(30) Foreign Application Priority Data
Aug. 16, 2012 (CN) 201210292249.5

(51) Int. Cl. G06F 9/54; G06F 9/44

(52) U.S. Cl. CPC G06F 9/541; G06F 8/31

(57) ABSTRACT

A method and apparatus for implementing an extended application are provided. The method includes: receiving, by the first browser, calling of an API of the second browser performed by the extended application of the second browser, in the adapter mode; converting, by the first browser, the calling of the API of the second browser into calling of an API of the first browser; executing, by the extended application of the second browser in the first browser, functions of the extended application of the second browser by performing the calling of the API of the first browser.

### CROSS-REFERENCE TO RELATED APPLICATIONS

This application is a continuation of International Patent Application No. PCT/CN2013/081449, filed on Aug. 14, 2013. This application claims the benefit and priority of Chinese Application No. 201210292249.5, filed Aug. 16, 2012. The entire disclosures of each of the above applications are incorporated herein by reference.

### FIELD OF THE INVENTION

The present invention relates to computer application technologies, and more particularly, to a method and apparatus for implementing an extended application.

### BACKGROUND OF THE INVENTION

Currently, when a browser supporting extended applications installs and loads an extended application, new functions are added to the browser. The extended application is a set of series files. After the extended application is loaded by the browser, interface elements of the extended application are added to the browser and responses are made when the interface elements are operated by a user to implement corresponding functions. The interface elements of the extended application include buttons, menus and etc. For example, a chrome browser supports a mouse gestures extended application, after the chrome browser loads the mouse gestures extended application, the user may make a page go forward or backward, or close a page, by drawing a specific line with the mouse in a page area.

The above extended application may be developed by using extended application writing specifications provided by the browser. In the descriptions of the examples of the present invention, the extended application developed by using the extended application writing specifications provided by the browser is referred to as the extended application of the browser. Generally, different browsers provided different extended application writing specifications. Thus, the extended application of the browser of one type can be used in the browser of the type, and cannot be used in the browsers of other types. For example, extended applications of a chrome browser can be used in the chrome browser, and cannot used in a Firefox browser.

As can be seen, in existing technologies, the browser is not compatible with the extended applications of the browsers of the different types.

### SUMMARY OF THE INVENTION

Examples of the present invention provide a method and apparatus for implementing an extended application, so that a browser of one type is compatible with an extended application of browsers of other types.

A method for implementing an extended application in a browser in which an extended application of a second browser is installed on a first browser, the first browser is configured with an adapter mode, and a type of the first browser is different from a type of the second browser, includes:

receiving, by the first browser, calling of an API of the second browser performed by the extended application of the second browser, in the adapter mode;

converting, by the first browser, the calling of the API of the second browser into calling of an API of the first browser;

executing, by the extended application of the second browser in the first browser, functions of the extended application of the second browser by performing the calling of the API of the first browser.

A method for implementing an extended application in which an extended application of a second browser is installed on a first browser, a type of the first browser is different from a type of the second browser, includes:

parsing, by the first browser, an interface description file of the extended application of the second browser, and obtaining interface description data of the extended application of the second browser;

converting, by the first browser, the interface description data of the extended application of the second browser into interface description data supported by the first browser;

storing, by the first browser, the converted interface description data of the extended application of the second browser in an interface data structure of the first browser; the interface data structure of the first browser being used to describe an interface presentation mode of the first browser;

reading, by the first browser, interface description data stored in the interface data structure of the first browser; the read interface description data comprising the interface description data of the extended application of the second browser;

displaying, by the first browser, a display interface of the extended application of the second browser in a display interface of the first browser, according to the interface description data of the extended application of the second browser.

An apparatus for implementing an extended application in a browser, applied to a first browser, an extended application of a second browser being installed on the first browser, the first browser being configured with an adapter mode, and a type of the first browser being different from a type of the second browser; the apparatus comprising a processor for executing instructions stored in a memory, the instructions comprise:

a receiving instruction, to receive calling of an API of the second browser performed by the extended application of the second browser, in the adapter mode;

a converting instruction, to convert the calling of the API of the second browser into calling of an API of the first browser;

an extended application instruction, to execute functions of the extended application of the second browser in the first browser by performing the calling of the API of the first browser.

An apparatus for implementing an extended application, applied to a first browser, an extended application of a second browser being installed on the first browser, a type of the first browser being different from a type of the second browser; the apparatus comprising a processor for executing instructions stored in a memory, the instructions comprise:

a parsing instruction, to parse an interface description file of the extended application of the second browser, and obtain interface description data of the extended application of the second browser;

a converting instruction, to convert the interface description data of the extended application of the second browser into interface description data supported by the first browser; store the converted interface description data of the extended application of the second browser in an interface data structure of the first browser; the interface data structure of the first browser being used to describe an interface presentation mode of the first browser;

a reading instruction, to read the interface description data stored in the interface data structure of the first browser; the read interface description data comprising the interface description data of the extended application of the second browser;

a display instruction, to display a display interface of the extended application of the second browser in a display interface of the first browser, according to the interface description data of the extended application of the second browser.

According to the examples of the present disclosure, in the adapter mode, the calling of the API of the second browser is converted into the calling of the API of the first browser, so that the extended application of the second browser may call the API in the first browser; the interface description file of the extended application of the second browser is parsed, and the interface description data of the extended application of the second browser is obtained; the interface description data of the extended application of the second browser is stored in the interface data structure of the first browser, so as to display the interface of the extended application of the second browser in the first browser; the extended description data of the extended application of the second browser is converted into the extended description data supported by the first browser according to the data format supported by the first browser, thereby managing the extended application of the second browser which includes but not limited to installing, loading, uninstalling the extended application, using and disabling the extended function. In this way, the first browser is compatible with the extended application of second browser. The first browser and the second browser are browsers of different types; the extended application of the second browser is an extended application developed by using extended application writing specifications provided by the second browser. Therefore, a browser of one type is compatible with an extended application of browsers of other types.

### BRIEF DESCRIPTION OF THE DRAWINGS

FIG. 1 is a schematic flowchart illustrating a method for implementing an extended application according to an embodiment of the present invention.

FIG. 2 is a schematic flowchart illustrating a method for implementing an extended application according to another embodiment of the present invention.

FIG. 3 is a schematic flowchart illustrating a method for implementing an extended application according to another embodiment of the present invention.

FIG. 4 is a schematic diagram illustrating a browser according to an embodiment of the present invention.

FIG. 5 is a schematic diagram illustrating a browser according to another embodiment of the present invention.

FIG. 6 is a schematic diagram illustrating a browser according to another embodiment of the present invention.

### DETAILED DESCRIPTION OF THE INVENTION

In order to make the technical solution and merits of the present invention clearer, the present invention will be illustrated in detail hereinafter with reference to the accompanying drawings and specific examples.

According to an example, a method for implementing an extended application is implemented via three parts:

an extended application of a second browser calls an API in a first browser, so as to implement functions of the extended application of the second browser;

an interface display of the extended application of the second browser is implemented in the first browser, so as to display an interface of the extended application of the second browser in the first browser;

the extended application of the second browser is managed in the first browser, so that the user may manage the extended application of the second browser in the first browser.

The first browser and the second browser are browsers of different types, e.g. the chrome browser and the Firefox browser. The extended application of the second browser is an extended application developed by using extended application writing specifications provided by the second browser. In examples of the present invention, all of the browsers having the type different from that of the first browser are called the second browser, that is, the number of types of the second browsers is not limited.

In the following descriptions, one of the extended applications of the second browser is implemented in the first browser, that is, one extended application of other browsers is implemented in the browser. Similarly, by using the method provided by the examples, multiple extended applications of other browsers may be implemented in the browser.

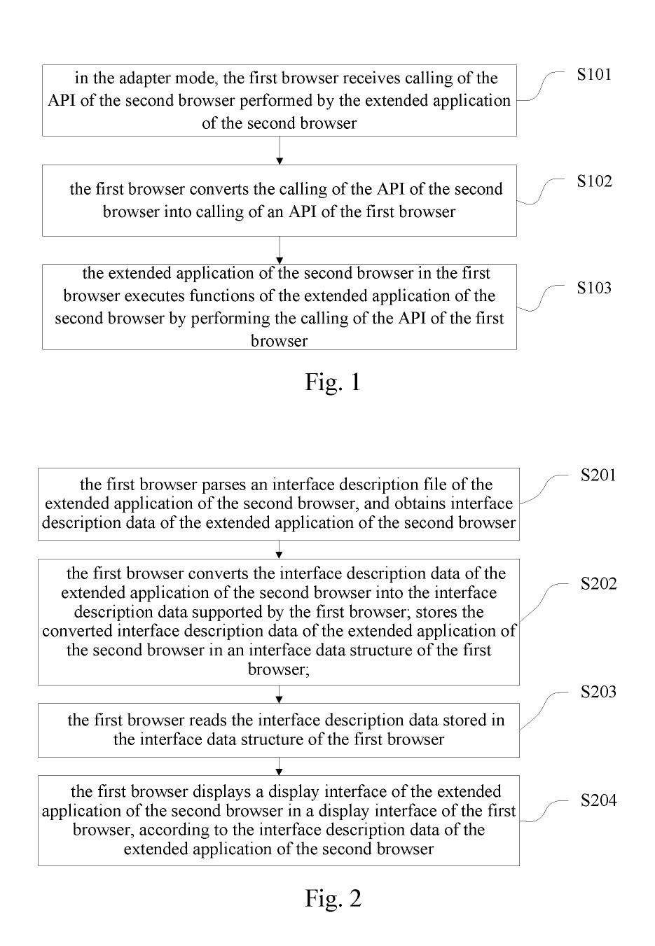

FIG. 1 is a schematic flowchart illustrating a method for implementing an extended application according to an embodiment of the present invention. The method is used to call an API by an extended application of a second browser in a first browser.

The extended application of the second browser is installed on the first browser, and the first browser is configured with an adapter mode, a type of the first browser is different from a type of the second browser.

In an application scenario of the example, the first browser is started up and loads the extended application of the second browser, when a user wants to use a certain function of the extended application of the second browser, if the user selects an option corresponding to the function in a display interface of the extended application of the second browser, the extended application of the second browser needs to call an Application Programming Interface (API) of the second browser to implement the function, thus the method for implement the extended application in the browser includes the following processing.

In block S101, in the adapter mode, the first browser receives calling of the API of the second browser performed by the extended application of the second browser.

In the adapter mode, an API of one class may be converted into an API of another class, so that the classes which are not compatible with each other can work together.

The API of the second browser may be obtained by the user from the extended application writing specifications and may be stored in a designated area. The designated area may be storage accessible by the first browser in a computer system of the browser.

In block S102, the first browser converts the calling of the API of the second browser into calling of an API of the first browser.

According to example, the extended application of the second browser calls the API of the second browser by using a first computer programming language, after the conversion, the extended application of the second browser calls the API of the first browser by using a second computer programming language. The first computer programming language includes: JS language or C++ language; the second computer programming language includes: JS language or C++ language.

According to example, the first computer programming language and the second computer programming language may be the same language or different languages.

For example, the extended application of the second browser calls the API of the second browser by using the JS language, after the conversion, the extended application of the second browser may call the API of the first browser by using the JS language or C++ language.

In block S103, the extended application of the second browser in the first browser executes functions of the extended application of the second browser by performing the calling of the API of the first browser.

According to the example, in the adapter mode, the calling of the API of the second browser is converted into the calling of the API of the first browser, so that the extended application of the second browser may call the API in the first browser, and further implement the functions of the extended application of the second browser in the first browser.

FIG. 2 is a schematic flowchart illustrating a method for implementing an extended application according to another embodiment of the present invention. The method is to display an interface of an extended application of a second browser in a first browser. The extended application of the second browser is installed on the first browser, and a type of the first browser is different from a type of the second browser.

In an application scenario of the example, the first browser is started up and loads the extended application of the second browser, the first browser needs to load and display a display interface of the extended application of the second browser, thus the method for implement the extended application includes the following processing.

In block S201, the first browser parses an interface description file of the extended application of the second browser, and obtains interface description data of the extended application of the second browser.

The interface description file of the extended application of the second browser may be a Hypertext Markup Language (HTML) file or an Extensible Markup Language (XML) file or a file of other formats.

The browser may draw the display interface of the browser according to the interface description data.

Different browsers may support different formats of the interface description data. For example, when a button is displayed in the description interface, the length, width and height of the button may be indicated by a string or by three decimals.

Therefore, after obtaining the interface description data of the extended application of the second browser, if the format of the interface description data supported by the second browser is different from the format of the interface description data supported by the first browser, the first browser needs to convert the interface description data of the extended application of the second browser into the interface description data supported by the first browser.

In block S202, the first browser converts the interface description data of the extended application of the second browser into the interface description data supported by the first browser; stores the converted interface description data of the extended application of the second browser in an interface data structure of the first browser; the interface data structure of the first browser is used to describe an interface presentation mode of the first browser.

Different browsers have different interface description rules for the extended application. If the interface of the extended application of the second browser needs to be displayed in the first browser, the interface description data of the extended application of the second browser needs to be converted into a mode supported by the first browser.

The interface data structure of the first browser is a set of data for describing an interface presentation mode of the first browser, and may be constructed by using a Model, View, Controller (MVC) mode. After storing the interface description data of the extended application of the second browser in the interface data structure of the first browser, the first browser may draw the interface of the extended application of the second browser when drawing the interface of the first browser according to the interface data structure of the first browser.

The interface data structure of the first browser may be stored as a file; or the interface data structure of the first browser may be stored in a memory as a structure.

In block S203, the first browser reads the interface description data stored in the interface data structure of the first browser; the read interface description data includes the interface description data of the extended application of the second browser.

In block S204, the first browser displays a display interface of the extended application of the second browser in a display interface of the first browser, according to the interface description data of the extended application of the second browser.

According to the example, the interface description file of the extended application of the second browser is parsed, and the interface description data of the extended application of the second browser is obtained; the interface description data of the extended application of the second browser is stored in the interface data structure of the first browser, so as to display the interface of the extended application of the second browser in the first browser.

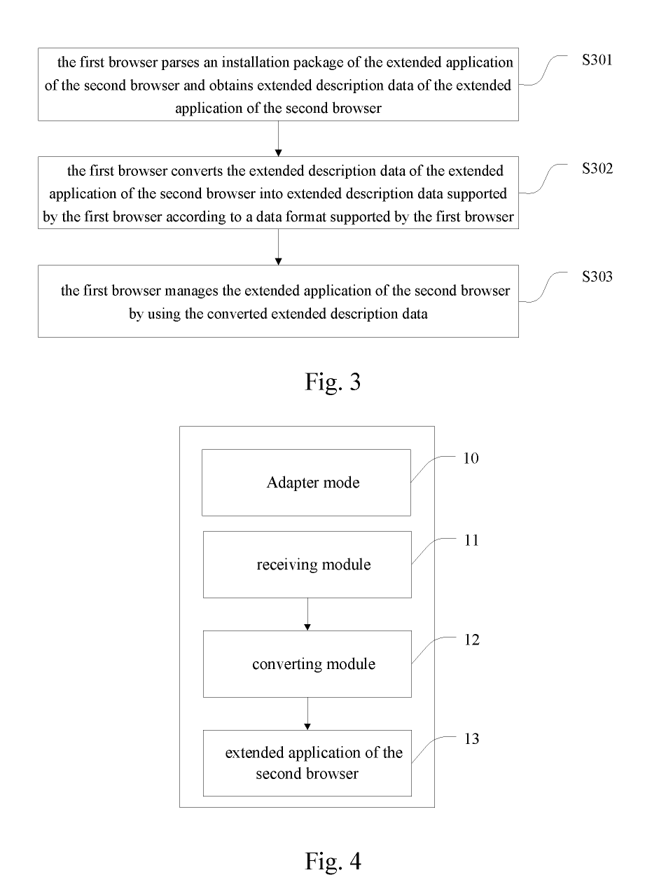

FIG. 3 is a schematic flowchart illustrating a method for implementing an extended application according to another embodiment of the present invention. The method is to manage the extended application of the second browser in the first browser.

In an application scenario of the example, managements of the extended application of the second browser is performed in the first browser, and the management includes installing, loading, uninstalling the extended application of the second browser, using and disabling extended functions of the extended application of the second browser. The method for implement the extended application in the browser includes the following processing.

In block S301, the first browser parses an installation package of the extended application of the second browser and obtains extended description data of the extended application of the second browser.

A type of the first browser is different from a type of the second browser.

In block S302, the first browser converts the extended description data of the extended application of the second browser into extended description data supported by the first browser according to a data format supported by the first browser.

Since extended applications of different browsers have different formats of installation packages. For example, in the installation package of the extended application of the chrome browser, a main index file is called manifest.json, related information of the extended application is described in a JSON format, e.g. an extended name and a version number are included. In the installation package of the extended application of the Firefox browser, a main description file is called install.rdf, related information of the extended application is described in a XML format.

Therefore, if the first browser needs to support the installation package of the extended application of second browser, the installation package of the extended application of second browser needs to be parsed and converted into a data format supported by the first browser.

In block S303, the first browser manages the extended application of the second browser by using the converted extended description data. The management includes installing, loading, uninstalling the extended application of the second browser, using and disabling the extended functions of the extended application of the second browser.

According to the example, the extended description data of the extended application of the second browser is converted into the extended description data supported by the first browser according to the data format supported by the first browser, thereby managing the extended application of the second browser which includes but not limited to installing, loading, uninstalling the extended application, using and disabling the extended function.

As can be seen, by using the methods shown in FIGS. 1 to 3, the API is called by the extended application of the second browser in the first browse, the interface of the extended application of the second browser is displayed in the first browser and the extended application of the second browser is managed in the first browser. Therefore, a browser of one type is compatible with extended applications of browsers of other types.

FIG. 4 is a schematic diagram illustrating a browser according to an embodiment of the present invention. As shown in FIG. 4, the browser is a first browser, at least one extended application of a second browser is installed in the first browser, an adapter mode 10 is configured for the first browser, and a type of the first browser is different from a type of the second browser.

The first browser includes a receiving module 11, a converting module 12 and the extended application of the second browser 13.

The receiving module 11 is to receive calling of an API of the second browser performed by the extended application of the second browser, in the adapter mode.

The converting module 12 is to convert the calling of the API of the second browser into calling of an API of the first browser.

The extended application of the second browser 13 is to execute functions of the extended application of the second browser in the first browser by performing the calling of the API of the first browser.

According to an example, the calling of the API of the second browser is performed by using a first computer programming language; the calling of the API of the first browser is performed by using a second computer programming language.

The first computer programming language and the second computer programming language may be the same language or different languages.

The first computer programming language includes: a JavaScript (JS) language or a C++ language; the second computer programming language includes: a JS language or a C++ language.

According to the example, in the adapter mode, the calling of the API of the second browser is converted into the calling of the API of the first browser, so that the extended application of the second browser may call the API in the first browser, and further implement the functions of the extended application of the second browser in the first browser.

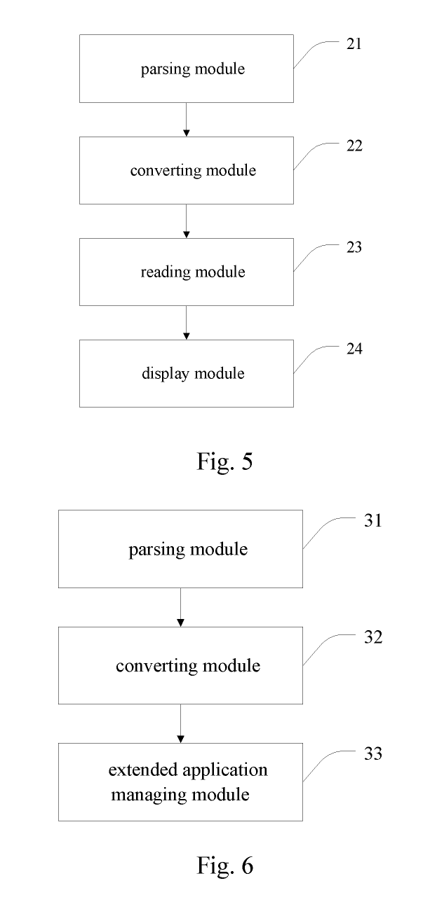

FIG. 5 is a schematic diagram illustrating a browser according to an embodiment of the present invention. The browser is a first browser, at least one extended application of a second browser is installed in the first browser, and a type of the first browser is different from a type of the second browser.

The first browser includes a parsing module 21, a converting module 22, a reading module 23 and a display module 24.

The parsing module 21 is to parse an interface description file of the extended application of the second browser, and obtain interface description data of the extended application of the second browser.

The converting module 22 is to convert the interface description data of the extended application of the second browser into the interface description data supported by the first browser; store the converted interface description data of the extended application of the second browser in an interface data structure of the first browser; the interface data structure of the first browser is used to describe an interface presentation mode of the first browser.

The reading module 23 is to read the interface description data stored in the interface data structure of the first browser; the read interface description data includes the interface description data of the extended application of the second browser.

The display module 24 is to display a display interface of the extended application of the second browser in a display interface of the first browser, according to the interface description data of the extended application of the second browser.

According to an example, the interface data structure of the first browser is stored as a file; or the interface data structure of the first browser is stored in a memory as a structure.

According to the example, the interface description file of the extended application of the second browser is parsed by the first browser, and the interface description data of the extended application of the second browser is obtained; the interface description data of the extended application of the second browser is stored in the interface data structure of the first browser, so as to display the interface of the extended application of the second browser in the first browser.

FIG. 6 is a schematic diagram illustrating a browser according to an embodiment of the present invention. The browser is a first browser. The first browser includes a parsing module 31, a converting module 32 and an extended application managing module 33.

The parsing module 31 is to parse an installation package of the extended application of the second browser and obtain extended description data of the extended application of the second browser; a type of the first browser is different from a type of the second browser.

The converting module 32 is to convert the extended description data of the extended application of the second browser into extended description data supported by the first browser according to a data format supported by the first browser.

The extended application managing module 33 is to manage the extended application of the second browser by using the converted extended description data; the management includes installing, loading, uninstalling the extended application of the second browser, using and disabling the extended functions of the extended application of the second browser.

According to the example, the first browser converts the extended description data of the extended application of the second browser into extended description data supported according to the data format supported by the first browser, thereby managing the extended application of the second browser which includes but not limited to installing, loading, uninstalling the extended application, using and disabling the extended function.

As can be seen, by using the first browser shown in FIGS. 4 to 6, the API is called by the extended application of the second browser in the first browse, the interface of the extended application of the second browser is displayed in the first browser and the extended application of the second browser is managed in the first browser. Therefore, a browser of one type is compatible with extended applications of browsers of other types.

The methods and modules described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided, which is to store instructions to cause a machine to execute a method as described herein. Specifically, a system or apparatus having a storage medium that stores machine-readable program codes for implementing functions of any of the above examples and that may make the system or the apparatus (or CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above examples.

In addition, the program codes implemented from a storage medium are written in storage in an extension board inserted in the computer or in storage in an extension unit connected to the computer. In this example, a CPU in the extension board or the extension unit executes at least part of the operations according to the instructions based on the program codes to realize a technical scheme of any of the above examples.

The foregoing is only preferred examples of the present invention and is not used to limit the protection scope of the present invention. Any modification, equivalent substitution and improvement without departing from the spirit and principle of the present invention are within the protection scope of the present invention.

1. A method for implementing an extended application, an extended application of a second browser being installed on a first browser, the first browser being configured with an adapter mode, and a type of the first browser being different from a type of the second browser; the method comprising:
receiving, by the first browser, calling of an Application Programming Interface (API) of the second browser performed by the extended application of the second browser, in the adapter mode;
converting, by the first browser, the calling of the API of the second browser into calling of an API of the first browser; and
executing, by the extended application of the second browser in the first browser, functions of the extended application of the second browser by performing the calling of the API of the first browser.

2. The method of claim 1, wherein the API of the second browser is stored in storage accessible by the first browser.

3. The method of claim 1, wherein the calling of the API of the second browser is performed by using a first computer programming language; the calling of the API of the first browser is performed by using a second computer programming language;
the first computer programming language and the second computer programming language being the same language or different languages.

4. The method of claim 1, wherein the first computer programming language comprises: JS language or C++ language; and the second computer programming language comprises: JS language or C++ language.

5. A method for implementing an extended application, an extended application of a second browser being installed on a first browser, a type of the first browser being different from a type of the second browser; the method comprising:
parsing, by the first browser, an interface description file of the extended application of the second browser, and obtaining interface description data of the extended application of the second browser;
converting, by the first browser, the interface description data of the extended application of the second browser into interface description data supported by the first browser;
storing, by the first browser, the converted interface description data of the extended application of the second browser in an interface data structure of the first browser; the interface data structure of the first browser being used to describe an interface presentation mode of the first browser;
reading, by the first browser, interface description data stored in the interface data structure of the first browser; the read interface description data comprising the interface description data of the extended application of the second browser; and
displaying, by the first browser, a display interface of the extended application of the second browser in a display interface of the first browser, according to the interface description data of the extended application of the second browser.

6. The method of claim 5, wherein the interface data structure of the first browser is stored as a file; or the interface data structure of the first browser is stored as a structure in a memory.

7. The method of claim 5, wherein the interface description file of the extended application of the second browser comprises a Hypertext Markup Language (HTML) file or an Extensible Markup Language (XML) file.

8. The method of claim 5, wherein interface data structure of the first browser is constructed by using a Model, View, Controller (MVC) mode.

9. An apparatus for implementing an extended application, applied to a first browser, an extended application of a second browser being installed on the first browser, the first browser being configured with an adapter mode, and a type of the first browser being different from a type of the second browser; the apparatus comprising a processor for executing instructions stored in a memory, the instructions comprise:
a receiving instruction, to receive calling of an API of the second browser performed by the extended application of the second browser, in the adapter mode;
a converting instruction, to convert the calling of the API of the second browser into calling of an API of the first browser; and
an extended application instruction, to execute functions of the extended application of the second browser in the first browser by performing the calling of the API of the first browser.

10. The apparatus of claim 9, wherein the calling of the API of the second browser is performed by using a first computer programming language; the calling of the API of the first browser is performed by using a second computer programming language;
the first computer programming language and the second computer programming language being the same language or different languages.

11. The apparatus of claim 9, wherein the first computer programming language comprises: JS language or C++ language; and the second computer programming language comprises: JS language or C++ language.

12. An apparatus for implementing an extended application, applied to a first browser, an extended application of a second browser being installed on the first browser, a type of the first browser being different from a type of the second browser; the apparatus comprising a processor for executing instructions stored in a memory, the instructions comprise:
a parsing instruction, to parse an interface description file of the extended application of the second browser, and obtain interface description data of the extended application of the second browser;
a converting instruction, to convert the interface description data of the extended application of the second browser into interface description data supported by the first browser; store the converted interface description data of the extended application of the second browser in an interface data structure of the first browser; the interface data structure of the first browser being used to describe an interface presentation mode of the first browser;
a reading instruction, to read the interface description data stored in the interface data structure of the first browser; the read interface description data comprising the interface description data of the extended application of the second browser; and
a display instruction, to display a display interface of the extended application of the second browser in a display interface of the first browser, according to the interface description data of the extended application of the second browser.

13. The apparatus of claim 12, wherein the interface data structure of the first browser is stored as a file; or the interface data structure of the first browser is stored as a structure in a memory.

14. The apparatus of claim 12, wherein the interface description file of the extended application of the second browser comprises a Hypertext Markup Language (HTML) file or an Extensible Markup Language (XML) file.

15. The apparatus of claim 12, wherein interface data structure of the first browser is constructed by using a Model, View, Controller (MVC) mode.
